(19) United States
(12) Patent Application Publication
(10) Pub. No.: US 2021/0133817 A1
(43) Pub. Date: May 6, 2021

(54) Information Recommendation Method and Apparatus

(71) Applicant: Huawei Technologies Co., Ltd., Shenzhen (CN)

(72) Inventors: Zhihong Qiu, Shenzhen (CN); Quan Qi, Shenzhen (CN)

(21) Appl. No.: 17/109,629

(22) Filed: Dec. 2, 2020

Related U.S. Application Data
(63) Continuation of application No. 14/333,784, filed on Jul. 17, 2014.
Application No. 14/333,784 is a continuation of application No. PCT/CN2013/070158, filed on Jan. 7, 2013.

(30) Foreign Application Priority Data
Jun. 27, 2012 (CN) 201210215463.0

(51) Int. Cl. G06Q 30/02; G06F 16/9535; G06Q 50/00

(52) U.S. Cl. CPC G06Q 30/0269; Y04S 50/14; G06Q 50/01; G06F 16/9535

(57) ABSTRACT

An information recommendation method and apparatus are provided. The method includes: acquiring, by using an open interface of a first network platform, relational data information of a user associated with a user of a second network platform; dividing, according to the relational data information of the user, each friendship circle obtained by dividing according to a preset division policy, so as to divide one friendship circle into a plurality of different social circles; and recommending, by using a preset recommendation policy, information in each of the social circles according to an acquired behavior record of each user on the second network platform. The embodiments of the present invention further provide an information recommendation apparatus. In the embodiments, information can be recommended by using an interface and user data that are open on a social website to increase accuracy of information recommendation.

### CROSS-REFERENCE TO RELATED APPLICATIONS

This application is a continuation of U.S. patent application Ser. No. 14/333,784 filed on Jul. 17, 2014, which is a continuation of International Patent Application No. PCT/CN2013/070158 filed on Jan. 7, 2013, which claims priority to Chinese Patent Application No. 201210215463.0 filed on Jun. 27, 2012. All of the aforementioned patent applications are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of Internet technologies, and in particular, to an information recommendation method and apparatus.

### BACKGROUND

In the electronic commerce (e-commerce) field, with continuous expansion of an e-commerce scale and a rapid increase of commodity quantity and categories, a customer needs to spend a large amount of time in finding a desired commodity. Such a process of browsing a large quantity of unrelated information and products will undoubtedly cause loss of consumers that are submerged in a problem of information overloading. In the Internet field, as Blog, Wiki, and Microblog develop, a large quantity of network information is generated by an individual user. The information is disorderly organized and its quantity and credibility vary, and therefore a user needs to spend a large amount of time in finding the information that the user is interested in. To solve the foregoing problem, a personalized recommendation technology and a personalized recommendation engine emerge. The personalized recommendation technology is an important technology in the Internet field, especially in e-commerce. It can recommend, according to a characteristic of a user's interest and purchasing power, information and commodity that the user is interested in to the user. The personalized recommendation engine is an intelligent platform established on the basis of massive data mining, and is to help an e-commerce website and an internet information supply website provide their customers with a completely personalized decision-making support and information service.

Currently, the primary personalized recommendation technology is content-based recommendation and collaborative recommendation. The content-based recommendation refers to finding relevance of articles or information according to metadata of articles or content, and recommending articles or information related to the user's history of interest to the user. For example, the e-commerce website finds, based on a purchase record of the user, that user A always purchases historical books and user A has not purchased a currently best-selling historical book “article 3”; therefore the e-commerce web site infers that user A is a potential user of “article 3”, and recommends “article 3” to user A. The collaborative recommendation refers to finding the relevance of a user based on the user's historical behavior record, and making a recommendation according to an interest of another user related to the user. For example, the e-commerce website finds, based on the purchasing record of the user, that user A always purchases a same product as user C does in history; therefore the e-commerce website infers that user A and user C have a similar interest. The e-commerce website also finds, based on the purchasing record of the user, that user A has purchased “article 1”, whereas user C has not purchased it; therefore the e-commerce website infers that user C is a potential user of “article 1”, and recommends “article 1” to user C.

However, a recommendation method in the prior art applies only to a scenario in which recommendation is performed by using user data and historical data of the e-commerce website, and information recommendation is of relatively low accuracy.

### SUMMARY

Embodiments of the present invention provide an information recommendation method and apparatus, in which information can be recommended by using an interface and user data that are open on a social website, so as to increase accuracy of the information recommendation and provide a user with great convenience.

A first aspect of the embodiments of the present invention provides an information recommendation method, including: acquiring, by using an open interface of a first network platform, relational data information of a user associated with a user of a second network platform, where the relational data information includes user exchange information exchanged between users and user behavior information indicating behavior of a user; dividing, according to the relational data information of the user, each friendship circle obtained by dividing according to a preset division policy, so as to divide each friendship circle into a plurality of different social circles; and recommending, by using a preset recommendation policy, information to each of the social circles according to an acquired behavior record of each user on the second network platform.

Another aspect of the embodiments of the present invention provides an information recommendation apparatus, including: an acquiring module configured to acquire, by using an open interface of a first network platform, relational data information of a user associated with a user of a second network platform, where the relational data information includes user exchange information exchanged between the users and user behavior information indicating behavior of the user; a dividing module configured to divide, according to the relational data information of the user, each friendship circle obtained by dividing according to a preset division policy, so as to divide each friendship circle into a plurality of different social circles; and a recommending module configured to recommend, by using a preset recommendation policy, information to each of the social circles according to an acquired behavior record of each user on the second network platform.

A technical effect of the embodiments of the present invention is: acquiring, by using the open interface of the first network platform, the relational data information of the user associated with the user of the second network platform, dividing, according to the relational data information, each friendship circle into a plurality of different social circles, and recommending, according to the behavior record of the user on the second network platform, information in the social circles after division; the embodiments enable information to be recommended by using the interface and user data that are open on the social website, increasing the accuracy of information recommendation and providing the user with great convenience.

### BRIEF DESCRIPTION OF THE DRAWINGS

To describe the technical solutions in the embodiments of the present invention or in the prior art more clearly, the following briefly introduces the accompanying drawings required for describing the embodiments. The accompanying drawings in the following description show some embodiments of the present invention, and persons of ordinary skill in the art may still derive other drawings from these accompanying drawings without creative efforts.

FIG. 1 is a flowchart of Embodiment 1 of an information recommendation method according to the present invention;

FIG. 2 is a schematic diagram of a relationship of a friendship circle and a social circle according to Embodiment 1 of an information recommendation method of the present invention;

FIG. 3 is a flowchart of Embodiment 2 of an information recommendation method according to the present invention;

FIG. 4 is a schematic diagram of a collaborative recommendation process based on a social circle according to Embodiment 2 of an information recommendation method of the present invention;

FIG. 5 is a schematic diagram of a system architecture according to Embodiment 2 of an information recommendation method according to of present invention;

FIG. 6 is a flowchart of Embodiment 3 of an information recommendation method according to the present invention;

FIG. 7 is a schematic diagram of a content recommendation process based on a social circle according to Embodiment 3 of an information recommendation method of the present invention;

FIG. 8 is a schematic structural diagram of Embodiment 1 of an information recommendation apparatus according to the present invention; and

FIG. 9 is a schematic structural diagram of Embodiment 2 of an information recommendation apparatus according to the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. The described embodiments are a part rather than all of the embodiments of the present invention. All other embodiments obtained by persons of ordinary skill in the art based on the embodiments of the present invention without creative efforts shall fall within the protection scope of the present invention.

For an information recommendation scheme in the prior art, when an e-commerce website performs recommendation by using historical data generated by the e-commerce itself, a high degree of consistency exists among the historical data, information of a potential user, and information of an article to be recommended. The potential user refers to a user that purchased an article on the website, and the article to be recommended is the same as or very similar to the article that the user purchased in the historical data. Therefore, information recommendation needs to be performed for the e-commerce website by using historical data generated by a carrier's web site or a social web site, so as to overcome a defect that the foregoing recommended article or information does not have a high value to the user, whereas the conventional method for performing recommendation based on the historical data generated by the e-commerce web site itself does not directly apply to recommendation based on social data generated by the carrier's website or the social website. Because a development trend development of the Internet industry has changed in recent years, various carriers or service providers of social web sites are willing to have their various resources opened in a form of an application programming interface (API), so as to build themselves into open platforms and attract a developer to develop a value-added service on their platforms. Therefore, a new demand in the industry is how to perform article or information recommendation by using the interface and user data made open by the carriers or the service providers of the social websites. The present invention aims to solve the foregoing technical problem and propose an information recommendation method to perform accurate article or information recommendation by using the open resources of the carriers or the service providers of the social websites.

FIG. 1 is a flowchart of Embodiment 1 of an information recommendation method according to the present invention. As shown in FIG. 1, the information recommendation method provided by the embodiment may specifically include the following steps:

Step 101: Acquire, by using an open interface of a first network platform, relational data information of a user associated with each user of a second network platform.

The first network platform provided by the embodiment may specifically be a carrier web site or a social web site, such as Facebook, Twitter, and Sina Microblog, and the second network platform may specifically be an e-commerce web site, such as Taobao, JD, and Dangdang. In the embodiment, the first network platform provides an externally open API interface, and the second network platform may acquire the relational data information of the user by using the open interface of the first network platform, where the user is a user that is in association with the user of the second network platform, and the association herein refers to that users have same identity information on two network platforms. For example, a person registers with the first network platform and the second network platform by using a same account or different accounts to become a user of the two network platforms. The first network platform and the second network platform are two independent platforms and each has its own users, but the first network platform provides an externally open interface; therefore the second network platform may find, by using the open interface, a method for associating users of the two platforms, that is, the second network platform may identify, by using user registration information made open on the first network platform, such as an email address, identity of the user from the registration information, and then identify the identity of the user on the second network platform by using the user registration information on the second network platform itself. If identities of two users on the two network platforms are the same, the two users are associated users. The relational data information herein includes user exchange information exchanged between users, and user behavior information indicating behavior of a user, where the user exchange information may be a behavior of sending an email or a short message to each other between a user and the user's friends on the first network platform, or behaviors such as mutual browsing, reposting, and commenting on a blog or microblog, and text data related to these behaviors, which may be used to further divide a friendship circle of the user. The user behavior information may be information such as a blog or microblog posted by the user, which may be used to determine a personal preference property of the user.

Step 102: Divide, according to the relational data information of the user, each friendship circle obtained by dividing according to a preset division policy, so as to divide one friendship circle into a plurality of different social circles.

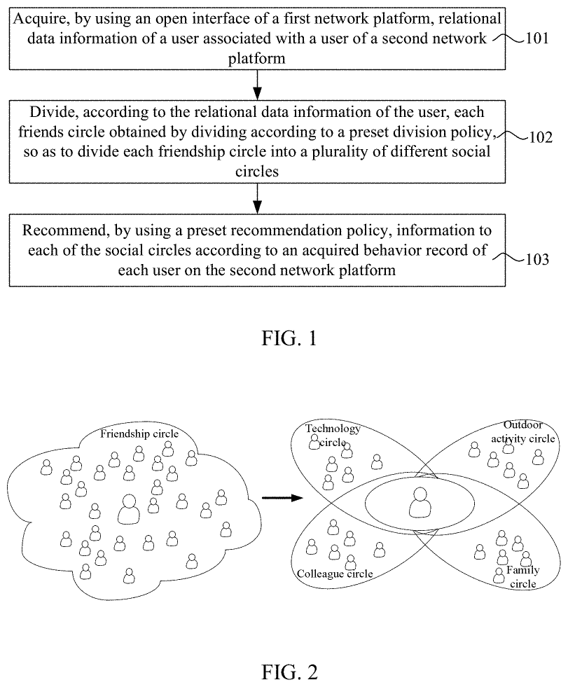

After the relational data information of the user is acquired, each friendship circle may be divided according to the relational data information, and specifically, one friendship circle is divided into a plurality of different social circles, where the friendship circle herein is acquired according to the preset division policy, and the division policy may be a user-centered division policy, and may also be a division policy in which division is performed according to a crowding level of networks. Users on a network may be divided into a plurality of friendship circles by using the preset division policy, and it is usually possible that one or several users are included in different friendship circles, that is, a situation in which different friendship circles have an overlap exists. In this step, further division of each friendship circle is performed according to the user exchange information and the user behavior information acquired from the first network platform, that is, a relationship, such as classmate, colleague, family, and an academic circle or a discussion circle about a theme, between the user and the user's friends may be determined according to an interaction between friends and a discussion topic posted or joined by the user, so that one friendship circle may be divided into a plurality of different social circles. FIG. 2 is a schematic diagram of a relationship between the friendship circle and the social circle in Embodiment 1 of the information recommendation method according to the present invention. As shown in FIG. 2, the friendship circle of a user is divided into four social circles: a technology circle, a colleague circle, a family circle, and an outdoor activity circle.

Step 103: Recommend, by using a preset recommendation policy, information to each of the social circles according to an acquired behavior record of each user on the second network platform.

After the division of the social circles is completed, this step is used to recommend, by using a preset recommendation policy, information to each social circle, where the recommendation policy may specifically be a collaborative recommendation policy, or a content recommendation policy, or a combination of a collaborative recommendation policy and a content recommendation policy. In the embodiment, with one social circuit as a unit, information is recommended by using the preset recommended policy and according to acquired behavior record of each user in the social circle on the second network platform, where the behavior record of the user on the second network platform may include a product purchasing record and an information browsing record of the user, and the like on the second network platform. Users in a social circle have a similar hobby, and focus on or care about a similar topic; therefore, an article or information with a high popularity in the social circle is recommended based on the social circle, and other users in the social circle usually may have an interest in the recommended article or information, so that accuracy of the recommendation is increased, and in addition, the user may acquire the article or information that interests the user without blind search, and convenience is also provided for the user.

The embodiment provides the information recommendation method: acquiring, by using the open interface of the first network platform, relational data information of the user associated with the user of the second network platform, dividing, according to the relational data information, each social circle into a plurality of different social circles, and recommending, according to the behavior record of the user on the second network platform, information to the social circles after the division. In this embodiment, information can be recommended by using the interface and user data that are open on the social website, which increases accuracy of information recommendation and provides the user with great convenience.

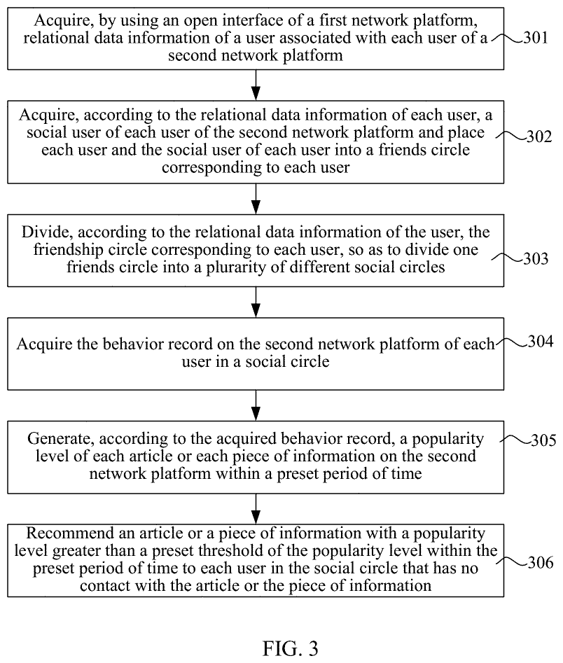

FIG. 3 is a flowchart of Embodiment 2 of an information recommendation method according to the present invention. As shown in FIG. 3, the information recommendation method provided by the embodiment may specifically include the following steps:

Step 301: Acquire, by using an open interface of a first network platform, relational data information of a user associated with each user of a second network platform.

In the embodiment, the first network platform provides an externally open API interface, and the second network platform may acquire the relational data information of the user by using the open interface of the first network platform, where the user is a user that is in association with the user of the second network platform, and the association herein refers to that users have the same identity information on the two network platforms. The first network platform and the second network platform are two independent platforms and each has its own users, but the first network platform provides an externally open interface; therefore the second network platform may find, by using the open interface, a method for associating users on the two platforms, that is, the second network platform may identify, by using user registration information on the first network platform, identity of the user from the registration information, and then identify the identity of the user on the second network platform by using the user registration information on the second network platform itself. If identities of two users on the two network platforms are the same, the two users are associated users.

Step 302: Acquire, according to the relational data information of each user, a social user of each user of the second network platform and place each user and the social user of each user into a friendship circle corresponding to each user.

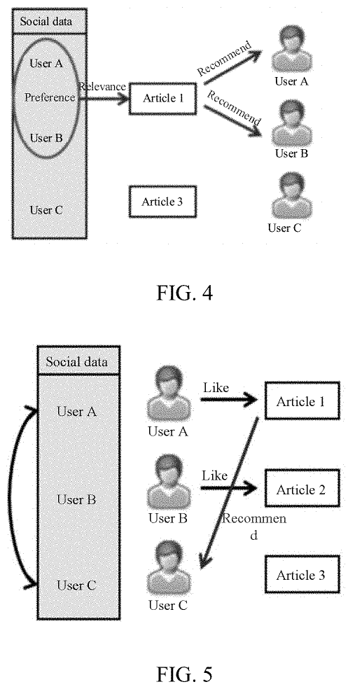

In the prior art, users purchasing a same article in history are considered as similar users, and after one user purchases a certain article, it may be considered that a user similar to the user is a potential customer of the article. However, a practical application shows that in the prior art this method for identifying a potential customer does not have high accuracy, and is prone to cause recommendation interference, that is, an article or information that the user is not interested in is recommended to the user, and frequent recommendation of this type will cause interference to the user to a certain degree. To overcome a defect that the foregoing recommendation in the prior art does not have high accuracy, analysis is performed, in the embodiment, on the relational data information of the user acquired from the first network platform to accurately identify the potential user. On a social network, a giant relational network exists among users. During potential customer identification, the social network needs to be split into a plurality of small sub-networks according to a topology structure of the social network, and a sub-network herein may be a friendship circle. In the embodiment, the social user of each user of the second network platform is acquired according to the relational data information of each user acquired from the foregoing steps. The social user of the user herein is a user that has a social relationship with the user, and the social relationship specifically refers to a problem discussion, commenting, microblog reposting, and the like among users by using the first network platform. In this step, the user and the social user of the user are placed into a friendship circle corresponding to the user; that is, with a certain user being a center, a friendship circle is formed by other users that have a social relationship with the user and the user, and the friendship circle is specifically a friendship circle of the user. A friendship circle of another user may further be established, with the another user being the center. Friendship circles corresponding to users are different from each other, but may possibly have an overlap part, that is, there is a mutual friend. FIG. 4 shows an established friendship circle. Specifically, a friendship circle possibly includes a plurality of layers of friend relationships. For example, a two-layer friend relationship is: presuming that user A is a center, user B is a friend of user A, user C is a friend of user B, then user C is also added to a friendship circle corresponding to user A.

Alternatively, in this embodiment, the friendship circle may also be formed by dividing according to a crowding level of the social network, that is, nodes that are closely connected with each other on the social network form a sub-network, and the sub-network is a friendship circle. The social network herein may be a network formed according to a relationship between users, and on the network, each node represents a user, two nodes that are connected with each other indicate that an interactive behavior exists between the two users, such as mutual browsing and mutual microblog reposting.

Step 303: Divide, according to the relational data information of the user, the friendship circle corresponding to each user, so as to divide one friendship circle into a plurality of different social circles.

In this step, after the friendship circle is obtained by division, because each friendship circle involves a very large user group, friends of the user need to be filtered to more accurately identify the potential customer. Specifically, further division of each friendship circle is performed according to the user exchange information and the user behavior information acquired from the first network platform, that is, a relationship, such as classmate, colleague, family, and an academic circle or a discussion circle about a theme, between the user and the user's friends may be determined according to an interaction between friends and a discussion topic posted or joined by the user, so that one friendship circle may be divided into a plurality of different social circles. As shown in FIG. 2, the friendship circle of a user is divided into four social circles: a technology circle, a colleague circle, a family circle, and an outdoor activity circle. A user of each of the social circles after division may be regarded as a potential customer of a type of a commodity or information.

Step 304: Acquire the behavior record of each user in a social circle on the second network platform.

In this embodiment, after the division is performed on each friendship circle to acquire its own social circle, information is recommended based on each social circle. Specifically, a content recommendation policy and/or collaborative recommendation policy may be adopted for recommendation, and this embodiment uses the collaborative recommendation policy as an example for description. In this step, an information recommendation process used in a social circle is used as an example. The behavior record of each user in a social circle on the second network platform is acquired first, where the behavior record includes an article purchasing record and an information browsing record.

Step 305: Generate, according to the acquired behavior record, a popularity level of each article or each piece of information on the second network platform within a preset period of time.

After the behavior record of each user in the social circle is acquired, the popularity level of each article or each piece of information on the second network platform may be generated according to the behavior record, where the popularity level herein may specifically be the popularity level of an article or a piece of information within a preset period of time. A method for generating the popularity level of an article or a piece of information may be set according to a practical situation. For example, after a user purchases an article on the second network platform, the popularity level of the article may increase by 1; alternatively, it may also be that after a user browses and collects an article on the second network platform, the popularity level of the article may also increase by 1, and after a user browses a piece of information on the second network platform, the popularity of the information may also increase by 1, and in this way, the popularity level of each article or each piece of information is generated. When an article or a piece of information has a higher popularity level, it indicates that the article or the piece of information is more popular. Certainly, the popularity level herein specifically corresponds to a social circle. The popularity level also varies with a length of time. If the time is preset to be short, the popularity of an article or a piece of information is low; if the preset time is long, the popularity of an article or a piece of information differs greatly.

Step 306: Recommend an article or a piece of information with a popularity level greater than a preset threshold of the popularity level within the preset period of time to each user in the social circle that has no contact with the article or the piece of information.

After the popularity level of the article or information is generated within the preset period of time on the second network platform, the article or information with a popularity level greater than the preset threshold of the popularity level within the preset period of time is recommended to each user in the social circle. Alternatively, the popularity levels of articles or pieces of information may be ranked in descending order, and articles or information ranking top may be directly recommended to each user in the social circle that has no contact with the article or the piece of information. Because users in a social circle have a similar hobby or interest, an article or information with a high popularity level is usually popular among the users in the social circle. FIG. 4 is a schematic diagram of a collaborative recommendation process based on a social circle according to Embodiment 2 of the information recommendation method of the present invention. As shown in FIG. 4, an article or information that is popular in a social circle is recommended to another user in the social circle that has no contact with the article or information. For example, in a social circle, if both user A and user B like and follow article 1, article 1 may be recommended to user C in the social circle.

FIG. 5 is a schematic diagram of a system architecture of Embodiment 2 of the information recommendation method. As shown in FIG. 5, an open interface provided by a carrier or a service provider of a social website includes a user identity acquiring interface, a friend relationship interface, a user behavior data interface, and a user registration information interface, and social data acquired from these interfaces includes user exchange information, user behavior information, and a user identity. Then, a recommendation engine performs, according to a user behavior record and an article or information record locally stored on an e-commerce website, a socialized network analysis such as friend extraction (that is, dividing a friendship circle), social circle extraction (that is, dividing a social circle), and calculation of a personal preference property and a circle preference property of a social circle. The recommendation engine further performs specific information recommendation by using the content recommendation policy and/or the collaborative recommendation policy, and displays a recommendation result to the user by using a Portal.

The embodiment provides the information recommendation method: acquiring, by using the open interface of the first network platform, relational data information of the user associated with the user on the second network platform, acquiring, according to the relational data information of each user, the social user of each user of the second network platform, placing sorts each user and the social user of each user into a friendship circle corresponding to each user, dividing, according to the relational data information, each friendship circle into a plurality of different social circles, and recommending, by using the collaborative recommendation policy and according to the behavior record of the user on the second network platform, information to the social circles after the division. The embodiment enables information to be recommended by using the interface and user data that are open on the social web site, increasing the accuracy of information recommendation and providing the user with great convenience.

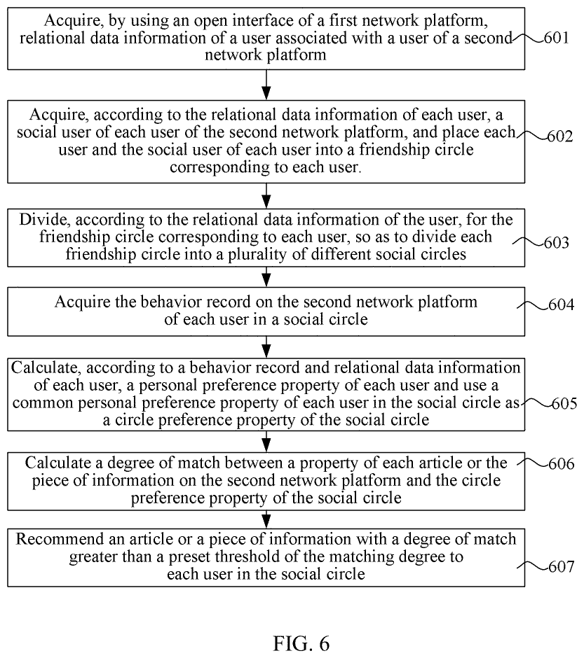

FIG. 6 is a flowchart of Embodiment 3 of an information recommendation method according to the present invention. As shown in FIG. 6, the embodiment provides an information recommendation method, which may specifically include the following steps:

Step 601: Acquire, by using an open interface of a first network platform, relational data information of a user associated with each user of a second network platform. This step may be similar to the foregoing Step 301, and is not further described herein.

Step 602: Acquire, according to the relational data information of each user, a social user of each user of the second network platform, and place each user and the social user of each user into a friendship circle corresponding to each user. This step may be similar to the foregoing Step 302, and is not further described herein.

Step 603: Divide, according to the relational data information of the user, the friendship circle corresponding to each user, so as to divide one friendship circle into a plurality of different social circles. This step may be similar to the foregoing Step 303, and is not further described herein.

Step 604: Acquire a behavior record of each user in a social circle on the second network platform.

In this embodiment, after the division is performed on each friendship circle to acquire its own social circle, information is recommended based on each social circle. Specifically, recommendation may be performed by using a content recommendation policy and/or a collaborative recommendation policy. This embodiment uses the content recommendation policy as an example for description. Refer to Embodiment 2 for a specific collaborative recommendation policy. In a scheme where the collaborative recommendation policy and the content recommendation policy are combined, an article or information obtained by using the collaborative recommendation policy is recommended to users in the same social circle, and in addition, an article or information obtained by using the content recommendation policy is also recommended to the users in the same social circle. This step describes an information recommendation process in a social circle as an example. The behavior record of each user in a social circle on the second network platform is acquired first, where the behavior record includes an article purchasing record and an information browsing record.

Step 605: Calculate, according to a behavior record and relational data information of each user, a personal preference property of each user and use a common personal preference property of each user in the social circle as a circle preference property of the social circle.

After the behavior record of each user and the relational data information of each user in the social circle are acquired, the personal preference property of each user is calculated according to the behavior record and the relational data information of each user. A user's preference may involve a plurality of aspects. For example, a user may discuss a technical problem in a certain field in a technology circle, may also discuss an activity route of a certain activity in an outdoor activity circle, and may further discuss an education problem of a child in a family circle. This embodiment may infer a user's hobby, that is, may acquire a user's personal preference property based on user exchange information such as a discussion and a communication between the user and the user's friends on the first network platform, user behavior information such as a microblog and a blog posted by the user on the second network platform, and the behavior record such as article purchasing and information browsing on the second network platform. The personal preference property of each user in a social circle may be acquired by using the foregoing method, and then the common personal preference property of each user in the social circle is used as the circle preference property of the social circle.

Step 606: Calculate a degree of match between a property of each article or the piece of information on the second network platform and the circle preference property of the social circle.

After the circle preference property of a social circle is acquired, the degree of match between the property of each article or each piece of information on the second network platform and the circle preference property of the social circle may be calculated, where the property of an article or a piece of information may be obtained according to a category and a characteristic of the article or the piece of information.

When the degree of match between the property of an article or a piece of information and the circle preference property is calculated, the property of the article or the piece of information and the circle preference property of the circle may be separately indicated by a vector, where the vector includes a feature term describing a property, and then a similarity between the two vectors is calculated. In a vector space model, D (Document) is used to indicate the vector, the feature term (Term, represented by T) indicates the feature term in the vector D, and the vector may be indicated by a feature term set D(T₁, T₂, . . . , Tₙ), where Tk is a feature term and 1<=k<=N. For example, a vector has four feature terms a, b, c, and d, and then the vector may be represented by D(a, b, c, d). For a vector that includes n feature terms, a certain weight is usually assigned to each feature term to indicate its importance. That is, D=D(T₁, W₁; T₂, W₂; . . . , Tₙ, Wₙ) is D=D(W₁, W₂, . . . , Wₙ) for short, where Wk is the weight of Tₖ, and 1<=k<=N. In the foregoing example, presuming that weights of a, b, c, and d are respectively 30, 20, 20, and 10, then the vector of the document is represented by D(30, 20, 20, 10). In the vector space model, the similarity Sim(D₁, D₂) between two documents D₁ and D₂ is usually denoted by a cosine value of an included angle between vectors, as shown in the following formula (1):

$$Sim ( {D}_{1} , {D}_{2} ) = cos θ = \frac{{\sum }_{k = 1}^{n} {W}_{1 k} \times {W}_{2 k}}{\sqrt{( {\sum }_{k = 1}^{n} {W}_{1 k}^{2} ) ( {\sum }_{k = 1}^{n} {W}_{2 k}^{2} )}} \qquad ( 1 )$$

where, W₁ₖ and W₂ₖ indicate the weight of the k^{th} feature term of document D₁ and D₂ respectively, and 1<=k<=N.

Step 607: Recommend an article or a piece of information with a degree of match greater than a preset threshold of the degree of match to each user in the social circle.

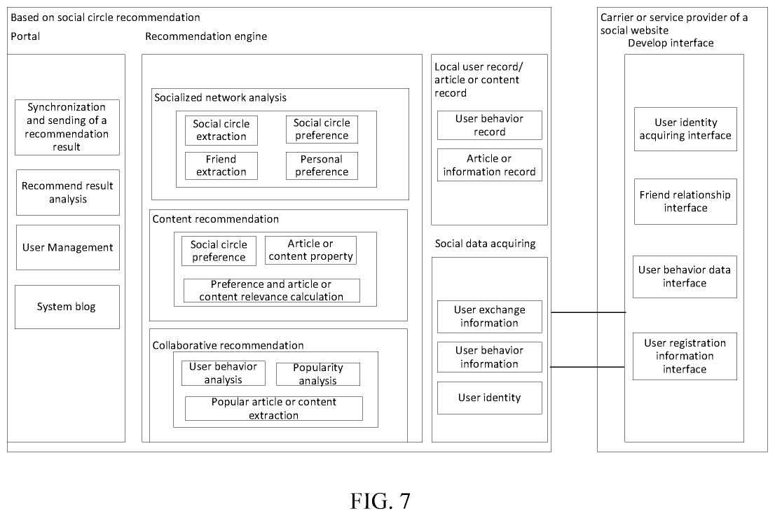

After the degree of match is acquired between the property of the article or information and the circle preference property of the social circle, the article or information with a degree of match greater than the preset threshold of the degree of match is recommended to each user of the social circle, that is, the article or information with a greater degree of match between the two properties is recommended to each user of the social circle. FIG. 7 is a schematic diagram of a content recommendation process based on a social circle of Embodiment 3 of an information recommendation method according to the present invention. As shown in FIG. 7, the article or information that matches the circle reference property of the social circle is recommended to each user of the social circle.

The embodiment provides the information recommendation method: acquiring, by using the open interface of the first network platform, relational data information of the user associated with the user on a second network platform, acquiring, according to the relational data information of each user, a social user of each user of the second network platform, placing each user and the social user of each user into a friendship circle corresponding to each user, dividing, according to the relational data information, each friendship circle into a plurality of different social circles, and recommending, by using the content recommendation policy and according to the behavior record of the user on the second network platform, information to the social circles after the division. The embodiment enables information to be recommended by using the interface and user data that are open on the social web site, increasing the accuracy of information recommendation and providing the user with great convenience.

Persons of ordinary skill in the art may understand that implementation of all or part of steps of the forgoing method embodiments may be completed by using a program that instructs a related hardware. The foregoing program may be stored in a readable storage medium of a computer. During implementation of the program, the implementation includes the steps of the foregoing method embodiments, whereas the foregoing storage medium includes: various mediums that may store a programming code, such as a read-only memory (ROM), a random-access memory (RAM), a disc, or a compact disc read-only memory (CD-ROM).

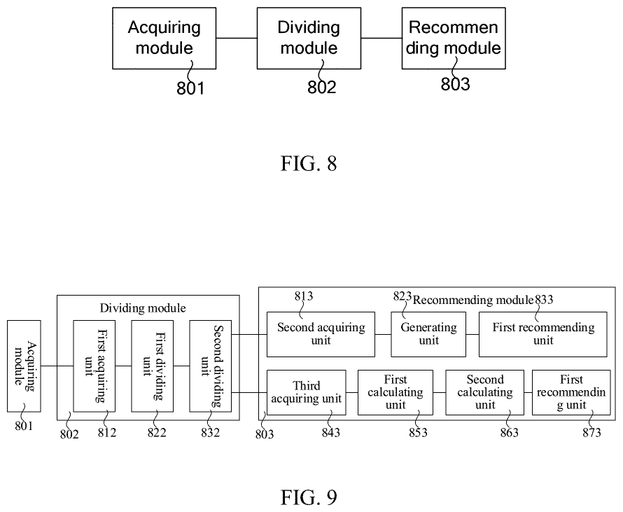

FIG. 8 is a schematic structural diagram of Embodiment 1 of an information recommendation apparatus according to the present invention. As shown in FIG. 8, the embodiment provides an information recommendation apparatus, which specifically can execute every step of Embodiment 1 of the foregoing method, and is not further described herein. The information recommendation apparatus provided in the embodiment may specifically include an acquiring module 801, dividing module 802, and a recommending module 803, where the acquiring module 801 is configured to acquire, by using an open interface of a first network platform, relational data information of a user associated with each user of a second network platform, where the relational data information includes user exchange information exchanged between users and user behavior information indicating behavior of a user; the dividing module 802 is configured to divide, according to the relational data information of the user, each friendship circle obtained by dividing according to a preset division policy, so as to divide one friendship circle into a plurality of different social circles; and the recommending module 803 is configured to recommend, by using a preset recommendation policy, information to each of the social circles according to an acquired behavior record of each user on the second network platform.

FIG. 9 is a schematic structural diagram of Embodiment 2 of an information recommendation apparatus according to the present invention. As shown in FIG. 9, the embodiment provides an information recommendation apparatus, which specifically can execute every step of Embodiment 2 of the foregoing method, and is not further described herein. The information recommendation apparatus provided by the embodiment is based on what is shown in FIG. 8, and the dividing module 802 may specifically include a first acquiring unit 812, a first dividing unit 822, and a second dividing unit 832, where the first acquiring unit 812 is configured to acquire, according to the relational data information of each user, a social user of each user of the second network platform, where the social user of each user is a user that has a social relationship with each user; the first dividing unit 822 is configured to place each user and the social user of each user into a friendship circle corresponding to each user; and the second dividing unit 832 is configured to divide, according to the relational data information of the user, the friendship circle corresponding to each user, so as to divide one friendship circle into a plurality of different social circles.

Specifically, the recommending module 803 in the embodiment may be configured to recommend, by using a collaborative recommendation policy and/or a content recommendation policy, information to each of the social circles according to an acquired behavior record of each user on the second network platform.

More specifically, the recommending module 803 in the embodiment may specifically include a second acquiring unit 813, a generating unit 823, and a first recommending unit 833, where the second acquiring unit 813 is configured to acquire a behavior record of each user in a social circle on the second network platform, where the behavior record includes an article purchasing record and an information browsing record; the generating unit 823 is configured to generate, according to the acquired behavior record, a popularity level of each article or each piece of information on the second network platform within a preset period of time; and the first recommending unit 833 is configured to recommend an article or a piece of information with a popularity level greater than a preset threshold of the popularity level within the preset period of time to each user in the social circle that has no contact with the article or the piece of information.

More specifically, the recommending module 803 in the embodiment may specifically include a third acquiring unit 843, a first calculating unit 853, a second calculating unit 863, and a second recommending unit 873, where the third acquiring unit 843 is configured to acquire the behavior record of each user in a social circle on the second network platform, where the behavior record includes the article purchasing record and the information browsing record; the first calculating unit 853 is configured to calculate, according to the behavior record and the relational data information of each user, a personal preference property of each user and use a common personal preference property of each user in the social circle as a circle preference property of the social circle; the second calculating unit 863 is configured to calculate a degree of match between a property of each article or each piece of information on the second network platform and the circle preference property of the social circle; and the second recommending unit 873 is configured to recommend an article or a piece of information with a degree of match greater than a preset threshold of the degree of match to each user in the social circle.

The embodiment provides the information recommendation apparatus, which acquires, by using the open interface of the first network platform, relational data information of the user associated with the user on a second network platform, acquires, according to the relational data information of each user, a social user of each user of the second network platform, places each user and the social user of each user into a friendship circle corresponding to each user, divides, according to the relational data information, each friendship circle into a plurality of different social circles, and recommends, by using the preset recommendation policy, information to the social circles after division according to the behavior record of the user on the second network platform. The embodiment enables information to be recommended by using the interface and user data that are open on the social web site, increasing the accuracy of information recommendation and providing the user with great convenience.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1. An information recommendation method implemented by a second network platform, comprising:
acquiring data made open on a first network platform, wherein the data includes registration information of a user of the first network platform;
identifying an identity of the user on the second network platform using the registration information;
acquiring relational data information including user exchange information exchanged between the user and other users having a social relationship with the user and user behavior information indicating behavior of the user, wherein the user exchange information includes interaction information associated with one or more interactions between the user and the other users;
obtaining a friendship circle of the user, wherein the friendship circle comprises the other users;
dividing the other users within the friendship circle into a plurality of different user groups by determining relationship types between the user and the other users using the user exchange information and the user behavior information, wherein each of the different user groups corresponds to a respective relationship type of a plurality of social relationship types between the user and the other users, and wherein the different user groups include a first user group including a plurality of first users;
acquiring a behavior record of each user in the first user group on the second network platform, wherein the behavior record comprises at least one of an article purchasing record or an information browsing record; and
recommending a product to each user in the first user group according to a popularity level of the product,
wherein the popularity level is based on the behavior record.

2. The information recommendation method of claim 1, wherein the user exchange information includes text data associated with one or more emails sent between the user and the other users.

3. The information recommendation method of claim 1, wherein the user exchange information includes text data associated with one or more short messages sent between the user and the other users.

4. The information recommendation method of claim 1, wherein the user is registered on the first network platform and the second network platform using a same account.

5. The information recommendation method of claim 1, wherein the interaction information comprises mutual browsing of a blog or a microblog.

6. The information recommendation method of claim 1, wherein the interaction information comprises reposting a blog or a microblog.

7. The information recommendation method of claim 1, wherein the interaction information comprises commenting on a blog or microblog.

8. The information recommendation method of claim 1, wherein the social relationship types include a first relationship type and a second relationship type, wherein the first relationship type is a family relationship, and wherein the second relationship type is a colleague relationship.

9. The information recommendation method of claim 1, wherein the first user group corresponds to a family relationship type.

10. The information recommendation method of claim 1, wherein the second network platform is an e-commerce website, and wherein the first network platform is a social website.

11. The information recommendation method of claim 1, wherein the interaction information comprises a discussion on a posted topic.

12. A second network platform comprising:
a processor; and
a non-transitory computer readable storage medium coupled to the processor and configured to store instructions that, when executed by the processor, cause the processor to:
acquire data of a first network platform, wherein the data includes registration information of a user of the first network platform;
identify an identity of the user on the second network platform using the registration information;
acquire relational data information including user exchange information exchanged between the user and other users having a social relationship with the user and user behavior information indicating behavior of the user, wherein the user exchange information includes interaction information associated with one or more interactions between the user and the other users;
obtain a friendship circle of the user, wherein the friendship circle comprises the other users;
divide the other users into a plurality of different user groups by determining relationship types between the user and the other users using the user exchange information and the user behavior information, wherein each of the different user groups corresponds to a respective relationship type of a plurality of social relationship types between the user and the other users, and wherein the different user groups include a first user group including a plurality of first users;
acquire a behavior record of each user in the first user group on the second network platform, wherein the behavior record comprises at least one of an article purchasing record or an information browsing record; and
recommend a product to each user in the first user group according to a popularity level of the product,
wherein the popularity level is based on the behavior record.

13. The second network platform of claim 12, wherein the interaction information comprises a discussion on a posted topic.

14. The second network platform of claim 12, wherein the interaction information comprises mutual browsing of a blog or a microblog.

15. The second network platform of claim 12, wherein the interaction information comprises reposting a blog or a microblog.

16. The second network platform of claim 12, wherein the interaction information comprises commenting on a blog or a microblog.

17. The second network platform of claim 12, wherein the social relationship types include a first relationship type and a second relationship type, wherein the first relationship type is a family relationship, and wherein the second relationship type is a colleague relationship.

18. The second network platform of claim 12, wherein the first user group corresponds to a family relationship type.

19. The second network platform of claim 12, wherein the second network platform is an e-commerce website, and wherein the first network platform is a social website.

20. An information recommendation method implemented by a second network platform, comprising:
acquiring data made open on a first network platform, wherein the data includes registration information of a user of the first network platform;
identifying an identity of the user on the second network platform using the registration information;
acquiring relational data information including user exchange information exchanged between the user and other users having a social relationship with the user and user behavior information indicating behavior of the user, wherein the user exchange information includes interaction information associated with one or more interactions between the user and the other users;
obtaining a friendship circle of the user, wherein the friendship circle comprises the other users;
dividing the other users into a plurality of different user groups by determining relationship types between the user and the other users using the user exchange information and the user behavior information, wherein each of the different user groups corresponds to a respective relationship type of a plurality of social relationship types between the user and the other users, and wherein the different user groups include a first user group including a plurality of first users;
acquiring a behavior record of each user in the first user group on the second network platform, wherein the behavior record comprises at least one of an article purchasing record or an information browsing record; and
recommending a product to each user in the first user group,
wherein a property of the product matches a common personal preference property of each user in the first user group, and
wherein a personal preference property of each user in the first user group is based on the behavior record.
